(19) United States
(12) Patent Application Publication
(10) Pub. No.: US 2007/0156479 A1
(43) Pub. Date: Jul. 5, 2007

(54) MULTIVARIATE STATISTICAL FORECASTING SYSTEM, METHOD AND SOFTWARE

(76) Inventor: Erik T. Long, Chicago, IL (US)

Correspondence Address: GROSS & ASSOCIATES, 1415 L STREET SUITE 1000, SACRAMETO, CA, 95814, US

(21) Appl. No.: 11/556,109

(22) Filed: Nov. 2, 2006

Related U.S. Application Data
(60) Provisional application No. 60/596,987, filed on Nov. 2, 2005.

(51) Int. Cl. G06F 9/44; G06F 17/50

(52) U.S. Cl. 705/7

(57) ABSTRACT

The software, methods and system of the current invention creates an interactive, auto-execution financial trading platform with unique forecasting algorithms, trading graphs and data mining features. The platform uses a univariate and multivariate architecture that is designed to improve performance of predictors and speed up calculations. Trading graphs, data mining features and predictive algorithms are predominantly based on fractal mathematics and Chaos theory. Even the unique software architecture is fractal in nature. All of these features are intended to be used individually or collectively to improve forecasting performance of financial markets. The above mentioned components also make it easier to manage a portfolio of securities and/or futures.

### CROSS REFERENCE TO RELATED APPLICATION

This nonprovisional application claims the benefit of Provisional Application No. 60/596,987 filed Nov. 2, 2005, which is incorporated herein by reference in its entirety and to which priority is claimed.

### BACKGROUND OF THE INVENTION

1. Field of Invention

The present invention relates generally to the field of stocks and commodities trading, and more specifically to methods, systems and software for providing a multivariate statistical forecasting system and trading platform.

2. Description of Related Art

Recently, there has been a marked increase in the number of individuals who have moved away from the traditional method of trading financial vehicles through broker services, and towards the use of electronic trading means and methods usable on a variety of devices such as the home computer or hand held devices with internet connectivity. Unfortunately, this means that those who opt to trade without the aid of experienced brokers risk making decisions without the benefit of years of market analysis or the ability to see future trends from past market performance.

Each day, the financial trading markets generate enormous amounts of data. Without the proper training or reference, much of this information will look meaningless or chaotic. Chaos is a term used to refer to a completely random state or unpredictable system. Examples of chaos in financial markets are price changes that appear to occur for no explainable reason. These are price changes that most Economists' believe are the norm in financial markets.

Chaotic systems become random or unpredictable because initial conditions have an increasing effect on the events that follow it. There is a point however where order and chaos can exist simultaneously. It is this “grey area” that is useful to financial traders. Financial traders can define certain limits in trading ranges even if specific events in those ranges appear random.

Chaos is the realm of the nonlinear, and therefore is important to financial traders. Since financial markets are chaotic, it is necessary to use nonlinear tools to forecast market dynamics. Despite financial markets being chaotic, finding regular patterns within the irregularity is important. Each time frame in a financial market will have a similar fractal pattern. This demonstrates that markets are natural phenomena, rather than mechanical processes. Because of this, principles applicable to nonlinear, natural systems should be effective in finding the regularity in the irregular patterns. Fractal geometry is an effective method for accurately forecasting price movement.

Technical traders are at a disadvantage because traditional technical analysis techniques are based upon linear equations and Euclidean Geometry. Markets are a function of nonlinear human activity. For instance, a market reversal is a nonlinear event, and therefore cannot be accurately forecast or modeled using linear equations and Euclidean Geometry. Technical Analysis is a poor indicator for the trend versus range trading decision. Conversely, Fractal Geometry is capable of quantifying what Euclidean Geometry cannot.

Fractals are a visual representation of a complex non-linear system like the markets. Markets also have a characteristic pattern that replicates across multiple time frames. The goal in trading the markets is to identify this replicating pattern and use it for buying or selling. Market prices tend to seek natural levels or ranges of balance. These levels or ranges can be described as “attractors”. Price attractors are natural levels that market prices are attracted to for whatever reason. These levels will remain within a global range, but the actual price itself is unpredictable. Once the price is determined, the levels can be used for future forecasting. Fractals are useful for identifying these price attractors in the market. These price attractors are also known as chaotic or fractal attractors. The global range of where the price attractors fall is known as “phase space”. These attractors have fractal dimensions.

Almost all chaotic systems have a quantifying measurement known as a fractal dimension. A fractal is an object in which individual parts are similar to the whole. The fractal dimension is a non-integer dimension that describes how an object takes up space. The fractal dimension is useful for traders, because it can be used to measure the irregularity of the market across scales with one number. The fractal dimension index (FDI) is a tool that applies the principles of chaos and fractal theory. This specialized market indicator identifies the fractal dimension of the market by using resealed range analysis and an estimated Hurst exponent. This is accomplished by using all available data on the time/price chart to determine the volatility or “trendiness” of a given financial market. Using this approach, the persistence or anti-persistence of any market can be determined.

The same fractal based analysis can be applied to any data set exhibiting chaotic or nonlinear randomness and which necessitates forecasting. Examples of such data include sports betting, weather forecasting, traffic patterns, terrorism, seismic activity and the like.

### SUMMARY OF THE INVENTION

Briefly, the present invention addresses the need for a forecasting system, method and software which can offer improved statistical analysis, charting, and predictive functions for random or chaotic data sets, and yet be user friendly enough that it can be used by both experts and amateurs for data analysis. The present inventions systems and methods can be used to analyze, model and forecast any random or chaotic data. The present invention also provides means for back forecasting and model verification as part of a unique risk management data analysis algorithm, allowing a high degree of accuracy and confidence in the forecasting models. The present invention also provides means for graphical representation and display of the results of data analysis including a novel charting means referred to as “The Cube”. The present invention also provides means to allow the user to set user defined preferences and instructions that allow automation and auto-execute functionality to data analysis and actions based on the results of the data analysis. The present inventions preferred embodiment is uniquely suited for financial data analysis and forecasting.

In one example the present invention provides a computer program product on a computer readable medium configured to allow; analysis of random or chaotic data, and more particularly financial data, which uses univariate, multivariate statistical models of arbitrary dimensions in infinite level layering networks and unique forecasting technology based on fractal metanet architecture, allowing for highly accurate predictive forecasting, while using an intuitive user interface and having computation times that approach 1000 times the rate of conventional forecasting platforms; receiving data feeds and communicating with the fractal metanet server; locally storing user preferences and instruction sets, tracking data vehicles of interest and maintaining analysis history of said data vehicles for comparison, and in the case of financial data, portfolio performance evaluation; an artificial intelligence system for data analysis and forecast model verification; charting and displaying the output of data analysis and forecasting models; automation and auto-execute functions for analysis output or transaction completion in the absence of continued Human interaction; third party vendor program add-ons or plug-ins through an application programming interface. The computer program product also provides real time three dimensional tracking of bid/ask data for financial vehicles of interest and novel means for financial data display, Lag Relay Cube and Price Attractor Cube. The invention also provides for a processor, which operates the steps necessary for computer program product execution.

Additionally, the present invention provides a computer program product, wherein on a computer readable medium a plurality of computer program codes are embodied in the medium. A computer executes the plurality of computer program codes to produce the computer program product. The computer program product comprises a plurality of data feeds; a plurality of random and chaotic data vehicles. The plurality of computer program codes are a first computer readable program code for communications connectivity and data feed access; a second computer readable program code to identify and track user defined data vehicles of interest; a third computer readable program code for performing statistical analysis and forecast modeling using univariate and unlimited dimension multivariate analysis algorithms and fractal metanet architecture based algorithms of at least one type of data selected from the plurality of random and chaotic data vehicles received from the plurality of data feeds, and produce an output of statistical data related to the plurality of random and chaotic data vehicles; a fourth computer readable program code for risk assessment the plurality of random and chaotic data vehicles; a fifth computer readable program code for comparing the output of statistical data by the computer program product to a set of user defined parameters and executing instructions based on the user defined parameters, as well as electronically executing a user configured instruction set for at least one of manually and automatically displaying and reporting of the statistically analyzed data; a sixth computer readable program code for integration of additional program codes and third party developed applications; and, a seventh computer readable program code for charting and displaying computer program product.

Still further the present invention provides for a random and chaotic data vehicle forecasting method comprising the steps of, inputting data feeds from a plurality of random and chaotic data vehicles; inputting a user profile to include user selected data vehicles from the plurality of random and chaotic data vehicles; and, analyzing and forecast modeling of the user selected data vehicles received from the data feeds, using univariate and unlimited dimension multivariate statistical analysis, wherein the analyzing and forecast modeling includes access to the plurality of data feeds, identifying and tracking the user selected data vehicles of interest, performing statistical analysis and forecast modeling using fractal metanet architecture based algorithms, and performing risk assessment forecasts on the user selected data vehicles. The method also displaying results of the analyzing and forecast modeling step.

In another example, the present invention provides a method for financial data vehicle forecasting and trading functionality using a computer program product based on fractal metanet architecture, the method further involving; detecting locally stored user selected data vehicles of interest (portfolio information); analyzing and forecast modeling of data received from a data feed using univariate and unlimited dimension multivariate statistical analysis based on and in conjunction with fractal metanet architecture and computations; an artificial intelligence system for data analysis and forecast model verification; comparing the results of the data analysis to user preferences for model verification and trading instruction execution; displaying results of data analysis according in accordance with user preferences; and executing user defined trading instructions. The method further provides means for real time three-dimensional tracking of bid/ask data for financial vehicles of interest and novel means of financial data forecasting display. The invention also provides for a processor, which operates the steps necessary for providing financial data vehicle forecasting and trading functionality using a computer program product based on fractal metanet architecture

In yet another example, the present invention provides a system for financial vehicle trading using fractal metanet forecasting of financial data vehicles, the system configured to allow; local storage of user portfolio information; access to a financial data feed to retrieve data for financial data vehicles of interest; access to a fractal metanet server for fractal based computations in conjunction with client software; display of financial analysis results according to user defined instructions; and automated trading functionality including auto-execution of trading instructions. The invention also provides for a processor, which operates the steps necessary for analyzing/forecast modeling of financial data and assessing risk of forecast financial data.

### BRIEF DESCRIPTION OF THE DRAWINGS

The drawings are provided for purposes of illustration only and not limitation. It should be noted that for clarity and ease of illustration, these drawings are not made to scale and that in some instances various aspects of the invention may be shown exaggerated or enlarged to facilitate an understanding of the invention. Various exemplary embodiments of the present invention will be described in detail, with reference to the following figures, wherein:

FIG. 1 is a block diagram of software architecture in accordance with the present invention;

FIG. 2 is a block diagram of information flow in a forecasting model specification in accordance with the present invention;

FIG. 3 is a block diagram of a flow chart of the method for providing financial data vehicle forecasting and trading functionality in accordance with the present invention;

FIG. 4 is a block diagram of a financial vehicle trading system in accordance with the present invention;

FIG. 5 is a block diagram of information flow within in the fractal metanet server in accordance with the present invention; and

FIG. 6 is a graph representative of The Cube in accordance with the present invention; and,

FIG. 7 is a graph representative of The Cube with data points in accordance with the present invention.

### DEFINITIONS

Data feed: Any Open High Low Close (OHLC) data feed or Bid/Ask/Price data feed.

Data vehicle: Futures contracts, Stocks, Forex, Mutual Funds or any other trading vehicle with the data from a data feed available.

Financial data vehicle of interest: Any symbol that corresponds to trading vehicles as described for Data Vehicle.

NaN values: The term NaN, which stands for “not a number,” means a symbolic entity that represents a value not otherwise available in floating-point format. There are two kinds of NaNs; Quiet, which represents unknown or uninitialized values, and Signaling, which represents symbolic values and values that are too big or too precise for the format. Signaling NaNs raise an invalid operation exception whenever an operation is attempted on them.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

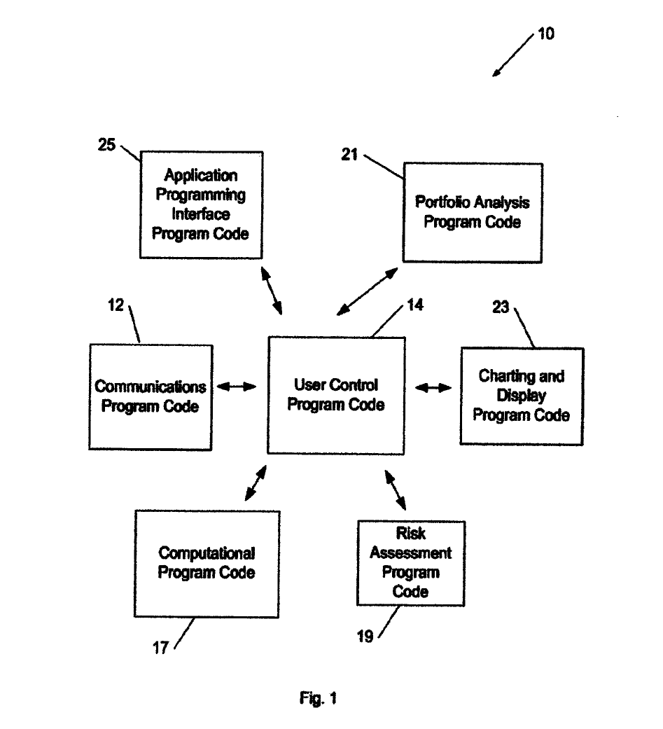

Referring now to FIG. 1, a computer program product 10 (also known as software, program code, FFCUBED) is illustrated. The computer program product 10 is an unlimited dimension multivariate statistical forecasting system and trading platform that can be applied to streaming live data for fast prediction and decision making. Data is processed at incredible speeds in the computer program product 10 due to the unique fractal metanet architecture of the computer program product 10. The computer program product 10 can also be modified to be multi-layered allowing data to be analyzed and mined for trading opportunities. The computer program product 10 enables automated forecasting, and uses auto-execution technology to create a trading platform that can trade independent of human interaction. The computer program product 10 contains within its architecture; a communications program code 12; a user control program code 14, also referred to as portfolio information; a computational program code 17; a risk assessment program code 19; a portfolio analysis program code 21; a program code for charting and display 23; and an application programming interface (API) program code 25 for integration of software updates and third party vendor plug-ins or add-ons. It will be understood that the arrows between various sections of program code indicate bi-directional information flow. It will also be understood that information flow between sections of program code not illustrated in FIG. 1 is also possible.

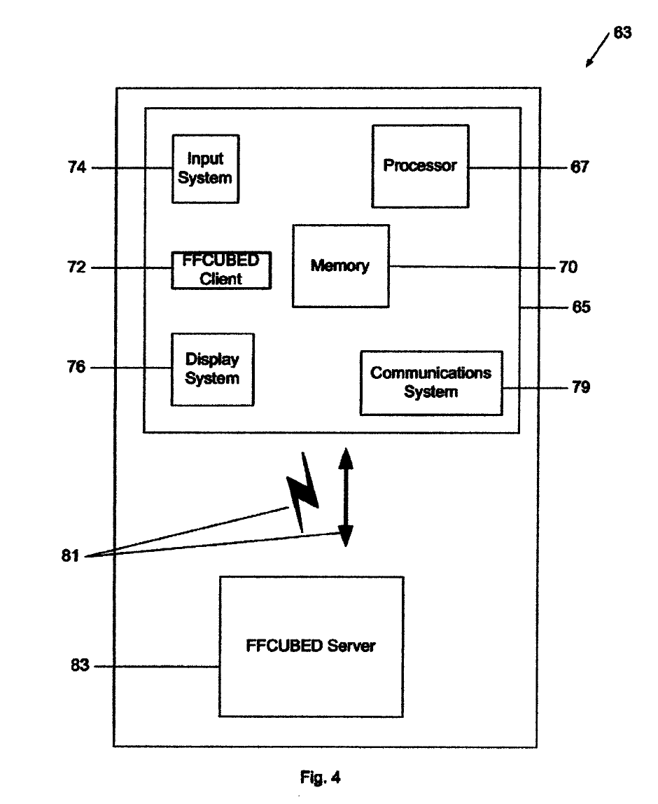

The computer program product 10 acting through a user device, as illustrated in FIG. 4, and the communications program code 12, establishes a communication path allowing access to; data feed(s), either End of Day (EOD) or intraday; the Fractal Metanet Server; and, third party vendors for software add-ons or plug-ins. Examples of data feeds include but are not limited to; financial data feeds such as tickers {add more names for this here} sports betting data feeds and the like. It will be understood that the act of communication between the computer program product 10, acting through the communications program code 12, and communications targets (data feeds, fractal metanet server, third party vendors) is often repeated or continuous communication. It will also be understood that user devices capable of executing the computer program product 10 are devices that contain a processor and means for communications connectivity and include but are not limited to; personal computers, laptop computers, mainframe computers, Smart phones, PDA's and the like. It will be further understood that the communications program code 12 enables communication connectivity, for example to the Internet and World Wide Web (www), using communications hardware resident in the user device executing the computer program product 10. It will be also be understood that communications technology and communications devices may be configured to operate on a multitude of service provider networks, and that network architecture and communications protocols are constantly evolving and emerging as technology becomes available and user requirements change. Therefore it will be understood that the description provided herein for the communications program code 12 encompasses code to allow communications connectivity using devices configurable to operate on any telecommunications network.

Referring again to FIG. 1, the computer program product 10 acting through user control program code 14 detects locally stored portfolio information containing user defined/chosen preferences for; data feed access; data vehicles of interest; preferred analysis algorithms; charting/graphing/data presentation; portfolio performance analysis (Portfolio Optimizer); display; auto-execution technology; third party vendor applications and the like. The computer program product 10 acting through communications program code 12 receives financial data from data feed, associates portfolio information contained in user control program code 14 with data feed, and determines which data vehicles of interest to track from data feed. It will be understood that data vehicles of interest include but are not limited to commodities, securities, stocks and the like. The user control program code 14 also; applies stored preferences for analysis and forecast modeling algorithms used on data received for data vehicles of interest, authenticates the computer program product 10 onto Fractal Metanet Server for fractal computations; applies preferences for portfolio performance analysis/calculations (Portfolio Optimizer); applies user preferences/instructions for auto-execution of financial trading functionality; and tracks/applies third party add-ons and plug-ins as necessary. It will be understood that user control program 14 acts in conjunction with processor and memory resident in the user device executing the computer program product 10, as illustrated in FIG. 4.

Referring again to FIG. 1, the computer program product 10 acting through the computational program code 17 performs statistical analysis and forecast modeling using statistical and fractal algorithms on data vehicles of interest. The data vehicles of interest are filtered by the user control program code 14 and applied to the data stream received from data feed through the communications program code 12. The computer program product 10 also contains within the computational program code 17, proprietary trading predictors (forecasting algorithms), indicators and filters that are used to forecast market movement. These predictors are a combination of fractal analysis, Bayesian statistics, nearest neighbor analysis and the like.

Algorithms

For purposes of definition and clarity, the statistical algorithms are separate from the forecast modeling or predictor algorithms. The computer program product 10 also contains within the computational program code 17 commonly known and available algorithms and statistical functions. The algorithms within the computational program code 17 located in the computer program product 10 perform the following: input control procedures for automatic conversion of raw data into a data series; monitoring and smart filtering of extreme values within data series; mutual synchronization and aggregation of datasets; multidimensional analysis of distributed lags; nonlinear regression (for instant prediction of a very short time series); a number of statistical tests, which detect seasonal components and estimate their characteristic times; non-seasonal ARIMA models for individual forecasting of medium and long time series; adaptive selection of seasonal ARIMA models; multiple fractal based analysis algorithms with confidence intervals for the future responses; selection of the regression model using a forward stepwise algorithm; leaps and bounds algorithm for determining a number of best regression subsets from a full regression model; and a special set of multivariate tests, which assist combining the above methods into a most effective model. The computational program code 17 contained within the computer program product 10 further provides a unique trading strategy devised around one step ahead predictors. Regardless of the predictor used, the computer program product 10 will enter trades based on a predefined entry threshold that may include commissions and slippage. Exits are defined by the user in an exit tolerance field that determines the range of risk (heat in trading terms) that will be tolerated in market moves opposite of the forecast. The combination of entry threshold, exit tolerance and any one step ahead predictor, as performed by the computer program product 10 acting through the computational program code 17, create an adaptable trading system with user defined risk and confidence levels. The computer program product 10 further enhances the commonly used algorithms, as well as the proprietary algorithms by enabling the ability to automatically merge these computational methods into a flexible and effective forecast model.

The forecasting algorithms (predictors) 36 and a brief description of the algorithms contained within computational program code 17 are provided below.

ARIMA—An autoregressive integrated moving average (ARIMA) model is a generalization of an autoregressive moving average or (ARMA) model. These models are fitted to time series data either to better understand the data or to predict future points in the series.

Finite State Markov Automation—A discrete, stochastic process in which the probability that the process is in a given state at a certain time depends only on the value of the immediately preceding state.

Inverse Fisher Cyber Cycle Zone—The Cyber Cycle is used in conjunction with the inverse Fisher transform. A cyber cycle is created by filtering and isolating the cycle components from the trend components of the inverse Fisher transform.

Inverse Fisher RSI Forecast—The purpose of the Inverse Fisher Transform is to alter the probability distribution function (PDF) of indicators. The Inverse Fisher Transform can be applied to any oscillator-type indicator such as the RSI (Relative Strength Indicator). The Inverse Fisher Transforms purpose is to alter the probability distribution function (PDF) of indicators.

MACD Crossover MA—Signals from the MACD Indicator can tend to lag behind price movements. The MACD Histogram is an attempt to address this situation showing the divergence between the MACD and its reference line (Exponential Moving Average) by normalizing the reference line to zero. As a result, the histogram signals can show trend changes well in advance of the normal MACD signal.

MACD Fractal Dim Zone—Signals from the MACD Indicator can tend to lag behind price movements. The MACD Histogram is an attempt to address this situation showing the divergence between the MACD and its reference line (Fractal Dimension Zone) by normalizing the reference line to zero. As a result, the histogram signals can show trend changes well in advance of the normal MACD signal.

Nonlinear Regression—Nonlinear least squares regression extends linear least squares regression for use with a much larger and more general class of functions. Almost any function that can be written in closed form can be incorporated in a nonlinear regression model. Unlike linear regression, there are very few limitations on the way parameters can be used in the functional part of a nonlinear regression model.

Polarized Fractal Dimension Trend—An exponentially smoothed ratio of the length of two lines: (1) of a straight line between the recent close and the close N steps ago, and (2) of a broken line connecting all Close points between the recent close and N steps ago. The result is polarized to create a fixed range oscillator.

It will be appreciated that the methods, algorithms, and functions used in financial analysis are continuously evolving and improving. It will also be appreciated that as technology and user requirements change these improved methods, algorithms, and analysis functions are easily integrated into the fractal metnanet architecture of computer program product 10 through program product updates and/or third party vendor applications, add-ons and plug-ins. Therefore it will be understood that the present invention includes methods, algorithms, analysis functions and technologies not currently available.

Time Series

The computer program product 10 acting through the computational code 17 and the user device, provide a novel means of handling time series data. Typically a time series is the sequence of observations ordered according to their dates. The computer program product 10 does not require that observations be separated with equal periods of time. In this way the actual observation time becomes the essential part of the model. The computer program product 10 acting through the computational code 17 operates on nonlinear fractal time. It drastically distinguishes the computer program product 10 and the unique combination of statistical and fractal algorithms contained within the computational code 17 from other statistical packages where only the order of observations plays a role.

Forecasting Model Specification

The computational program code 17 contained within the computer program product 10 forecast models and predicts trading trends using fractal algorithms, and can be applied to streaming data for fast prediction and decision making. Each forecasting model consists of three main parts: input data (for instance a data feed filtered by user defined data vehicles of interest via user control program code 14), output (data vehicles of interest for which statistical analysis has been performed), and a forecasting algorithm. Input data for computation of the forecasting model is the collection of time series. Output of the model is the collection of forecasted time series with probability limits and back-forecasts for model verification. The Forecasting algorithms are any function transforming input to output with good forecasting accuracy. It will be appreciated that the methods, algorithms, and functions used in financial analysis are continuously evolving and improving. It will also be appreciated that as technology and user requirements change these improved methods, algorithms, and analysis functions are easily integrated into the fractal metnanet architecture of computer program product 10 through program product updates and/or third party vendor applications, add-ons and plug-ins. Therefore it will be understood that the present invention includes methods, algorithms, analysis functions and technologies not currently available.

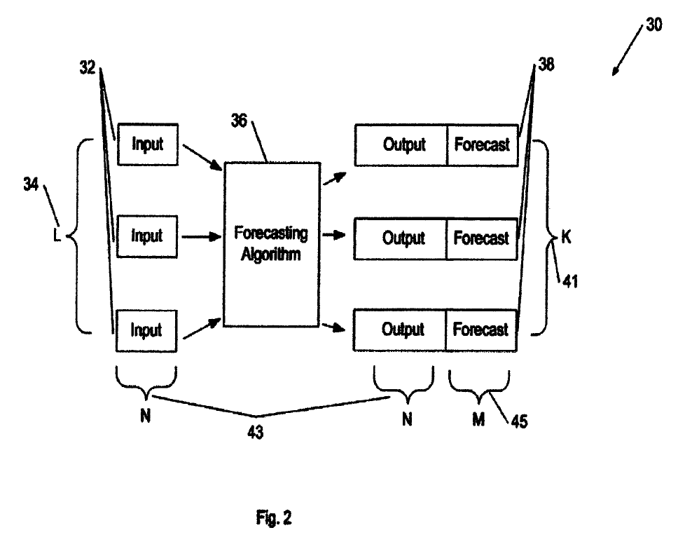

Referring now to FIG. 2. FIG. 2 illustrates a forecast modeling flowchart 30, with respect to information flow within the computational program code 17, illustrated in FIG. 1. The forecast modeling computation 30 comprises; individually illustrated input data 32; grouped input data of unlimited dimensions 34, represented as L; a forecasting algorithm 36 which transforms input to output with a high forecasting accuracy; individually illustrated output data with forecasts 38 (time series with probability limits and back-forecast for model verification) as computed by forecasting algorithm; grouped output data of unlimited dimensions with forecasts 41, represented as K. Also illustrated in the forecast modeling computation 30 are; N 43, representing the length of each input series, and M 45, representing the length of each forecast. N 43 and M 45 both have no upper limit to the length of data that can be input. Each input 32, 34 is the numeric array of length N 43. Each output 38 and 41 as computed by the forecasting algorithm 36, consists of two numeric arrays, ArrayForecast (portion of box labeled. ‘Output’ for reference number 38) and ArrayVariance (portion of box labeled ‘Forecast’ for reference number 38), each of length (N 43+M 45). ArrayForecast in its first N 43 positions contains back-forecasts at exactly the same time lags as the observed points of the input time series. ArrayForecast and ArrayVariance, collectively shown as Output 38 and 41, must be computed by the forecasting algorithm 36 for model verification. If some of the back-forecasts cannot be calculated, then the null values must be filled with NaN values. The last M positions of ArrayForecast must contain forecasts of one to M steps ahead. ArrayVariance must contain the variances of the forecasts, as computed by the forecasting algorithm 36, present in the ArrayForecast in exactly the same order or NaN, if the corresponding variance cannot be obtained.

Corresponding input 32, 34 and output data 38, 41 structures can be implemented in any programming language and may further contain additional functions for algorithm control and model storage. The computer program product 10 registers any dynamic link library (dll) that conforms to the specification in the unified algorithm repository (presented below) and selectively uses them in each case to provide the best forecast. The selective process involving an artificial intelligence system contained within the computer program product 10, acting through the computational program code 17, the risk assessment program code 19, and the portfolio analysis program code 21, in conjunction with the user device (illustrated in FIG. 4).

Unified Algorithm Repository

An example of the algorithm interface contained in the computation program code 17 (FIG. 1) as written in computer programming language C, is provided below. As mentioned previously, the data structures and algorithms can be implemented in any programming language and are integrated into the computer program product 10, through Application Programming Interface (API) 25. For ease of explanation and description, the algorithm functions are split into related groups for easier navigation. Most functions in the dll can be missed. In that case the computational framework, located in the computational program code 17 containing the forecasting algorithms 36, replaces them with default implementations that perform default processing.

Unified Specification of Interfaces to the Expert Shell and Algorithm Library.

Globally identify algorithm in algorithm library const char* AlgorithmName( )

This algorithm returns a user-friendly name of an algorithm implemented in the dll. If not implemented, the forecasting model name returned to the user as a valid-string is “Unknown”.

Forecasting Core Functions

int CalculateForecasts(int iNumInputs, int iInputLen, double*pInputMatrix, int iNumOutputs, int iForecastLen, double*pOutputMatrix, double*pVarianceMatrix, double*pDateTime, char*pSeriesNames, int iBufLen, void* pModelBuffer, int iParanLen, char* pModelParameters) This algorithm computes forecasts. If this function is omitted, all forecasts are considered as not existing. This function must be implemented for the forecasting algorithm 36 contained within the computational program code 17, to give any reasonable results. A further description of the algorithm functions is given below.

iNumInputs=Input. The total number of input series.

iInputLen=Input. The length of each input series.

pInputMatrix=Input. An array of size, exactly (iNumInputs*iInputLen), containing all the input series in the following order. First iInputLen elements contain first series, next iInputLen contain the second series, and so on until the last iNumInputs series is reached.

INumOutputs=Input. The total number of output series.

iForecastLen=Input. The desired length of the forecast.

pOutputMatrix=Output. pOutputMatrix presents a matrix of dimension (iNumOutputs*(iInputLen+iforecastLen)) to hold forecasts and back-forecasts calculated by the forecasting algorithms 36 contained within the computational program code 17. On completion it must hold the output series in the following order. First (iInputLen+IforecastLen) elements must contain the first output series, the second (iInputLen+IforecastLen) elements must contain the second, and so on until the last iNumOutputs series. Each output series in turn must hold in (2, . . . , iInputLen) locations the back-forecasts computed one step ahead, corresponding to exactly the same observed points of input series or NaN values, if corresponding back-forecast could not be calculated and returned null values. Locations (iInputLen+1, . . . , iInputLen+iForecastLen) of the output series 38, 41 must contain calculated forecasts (1, . . . , iForecastLen) steps ahead.

PVarianceMatrix=Output. pVarianceMatrix presents a matrix of dimension (iNumOutputs*(iInputLen+IforecastLen)) to hold the variances of forecasts and back-forecasts calculated by the forecasting algorithms 36 contained within computational program code 17, in exactly in the same order as pOutputMatrix.

pDateTime=Input/Output. The array of size (iInputLen+iForecastLen), which on input contains the timestamps of each observation in its first iInputLen locations. On output the array should contain expected timestamps of the forecasted values in its last iForecastLen locations and also may contain NaN values for timestamps of input observations to indicate that corresponding points were missed by algorithm. NaN timestamps of forecasted values indicates that the algorithm does not support future timestamp computations.

pSeriesNames=Input/Output. A null terminated string of names of input time series (input 32 or L 34 for time N 45) separated by new line characters (“\n”) in exactly the same order as they appear on pInputMatrix. The output contain the names of output series (output 38 or K 41 for time N 43+M 45) in exactly same order as they appear in pOutputMatrix.

iBufLen=Input. The size of the buffer holding the forecasted model information.

pModelBuffer=Output. The buffer holding the model information, which can be used subsequently by the forecasting algorithms, the next time updates are invoked. The computer program product 10 supports correct storage of this buffer in binary form, and provides the correct information in all subsequent calls of the algorithm. Each of the algorithms contained in the computational program code 17 or operating in conjunction with the computational program code 17, in the case of third party vendor algorithm add-ons, is free to store information in this buffer and request memory allocation for the information.

iParamLen=Input. The size of buffer holding the forecasting model parameters.

pModelParameters=Input. The buffer holding the model parameters specifying the various conditions for computing forecasts. This information can be interactively queried from the user through SettingsForm( . . . ) function.

int UpdateForecasts(int iNumInputs, int iInputLen, double* pInputMatrix, int iNumOutputs, int iForecastLen, double* pOutputMatrix, double* pVarianceMatrix, double* pDateTime, char* pSeriesNames, int iBufLen, void* pModelBuffer, int iParamLen, char* pModelParameters) This algorithm updates forecasts based on models previous computed by the forecasting algorithm 36 contained within the computational program code 17 and stored in memory resident in user device (illustrated in FIG. 4). If not supplied, a fast update option is not available for the model. If a fast update option is not available, the function CalculateForecasts( ) is called with the same set of parameters and information contained in pOutputIndex and pModelBuffer is erased. A further description of the algorithm functions is given below.

iNumInputs=Input. The total number of input series.

iInputLen=Input. The length of each input series.

pInputMatrix=Input. An array of size, exactly (iNumInputs*iInputLen), containing all the input series in the following order. First iInputLen elements contain first series, next iInputLen contain the second series, and so on until the last iNumInputs series is reached.

INumOutputs=Input. The total number of output series.

iForecastLen=Input. The desired length of the forecast.

pOutputMatrix=Output pOutputMatrix presents a matrix of dimension (iNumOutputs*(iInputLen+iforecastLen)) to hold forecasts and back-forecasts calculated by forecasting algorithms 36 contained within the computational program code 17. On completion it must hold the output series in the following order. First (iInputLen+IforecastLen) elements must contain the first output series the second (iInputLen+IforecastLen) elements must contain the second, and so on until the last iNumOutputs series. Each output series in turn must hold in (2, . . . , iInputLen) locations the back-forecasts computed one step ahead, corresponding to exactly the same observed points of input series or NaN values, if corresponding back-forecast could not be calculated. Locations (iInputLen+1, . . . , iInputLen+iForecastLen) of the output series 38, 41 must contain calculated forecasts (1, . . . , iForecastLen) steps ahead.

PVarianceMatrix=Output. pVarianceMatrix presents a matrix of dimension (iNumOutputs*(iInputLen+IforecastLen)) to hold the variances of forecasts and back-forecasts calculated by the forecasting algorithms 36 contained within the computational program code 17, in exactly in the same order as pOutputMatrix.

pDateTime=Input/Output. The array of size (iInputLen+iForecastLen) which on input contains the timestamps of each observation in its first iInputLen locations. On output the array should contain expected timestamps of the forecasted values in its last iForecastLen locations and also may contain NaN values for timestamps of input observations to indicate that corresponding points were missed by algorithm. NaN timestamps of forecasted values indicates that the algorithm does not support future timestamp computations.

pSeriesNames=Input/Output. A null terminated string of names of input time series (input 32 or L 34 for time N 45) separated by new line characters (“\n”) in exactly the same order as they appear on pInputMatrix. The output contain the names of output series (output 38 or K 41 for time N 43+M 45) in exactly same order as they appear in pOutputMatrix.

iBufLen=Input. The size of the buffer holding the forecasted model information.

pModelBuffer=Input. The buffer holding the model information previously stored during model computation.

iParamLen=Input. The size of buffer holding the forecasting model parameters.

pModelParameters=Input. The buffer holding the model parameters specifying the various conditions for computing forecasts. This information can be interactively queried from the user through SettingsForm( . . . ) function.

int ModelReport(int iReportLen, char* pReportBuffer, int iBufLen, void* pModelBuffer, int iParamLen, void* pModelParameters, int iPathLen, const char* pResPath) This algorithm describes a model based on information stored in buffer while it was computed by forecasting algorithm 36 contained within computational program code 17. If not supplied, no reporting option is available for the model. A further description of the algorithm functions is given below.

iReportLen—Input. The size of buffer holding the report of the model computed by forecasting algorithm 36 contained within computational program code 17.

pReportBuffer—Output. The buffer where the function must store the report. Html or text formats are expected.

iBufLen=Input. The size of the buffer holding the forecasted model information.

pModelBuffer=Input. The buffer holding the model information previously stored during model computation.

iParamLen=Input. The size of buffer holding the forecasting model parameters.

pModelParameters=Input. The buffer holding the model parameters specifying the various conditions for computing forecasts.

iPathLen=Input. The size of buffer holding the resource path.

pResPath=Input. The url path to the web server which processes the current model. Developers can upload their own graphics, charting applications and the like, to store on the server and use in their custom reporting.

int SettingsForm(int iFormLen, char* pFormBuffer, int iBufLen, void* pModelBuffer, int iParamLen, void* pModelParameters, int iPathLen, const char* pResPath, const char* pServerName) This algorithm prepares a custom web form asking the user for model settings/parameters. The query returns the acquired information in the pModelParameters buffer for later use by the CalculateForecasts( . . . ) and UpdateForecasts( . . . ) functions. If not supplied, settings changes are not supported for the model. A further description of the algorithm functions is given below.

iFormLen=Input. The size of buffer holding the custom web forms.

pFormBuffer=Output. The buffer wherein the algorithmic function must store the custom web forms. Html format coding/language is expected.

iBufLen=Input. The size of the buffer holding the forecasted model information.

pModelBuffer=Input. The buffer holding the model information previously stored during model computation.

iParamLen=Input. The size of buffer holding the forecasting model parameters.

pModelParameters=Input. The buffer holding the model parameters specifying the various conditions for computing forecasts.

iPathLen=Input. The size of buffer holding the resource path.

pResPath=Input. The url path to the web server which processes the current model. Developers can upload their own graphics, charting applications and the like, to store on the server and use in their custom reporting.

pServerPath=Input. The url path to the web server which processes the custom web form.

Functions to Estimate Buffers Needed.

int MaxBufferLen(int iNumInputs, int iInputLen, int iNumOutputs, int iForecastLen) This function returns the buffer allocation size requested from the algorithm to hold its model information. If not implemented, the standard 64 kb of buffer is allocated by default. A further description of the algorithm functions is given below.

iNumInputs=Input. The total number of input series.

iInputLen=Input. The length of each input series.

INumOutputs=Input. The total number of output series.

iForecastLen=Input. The desired length of the forecast.

int MaxParamLen(int iNumInputs, int iInputLen, int iNumOutputs, int iForecastLen)

This function returns the buffer allocation size requested from the algorithm to hold its parameters. If not implemented, the standard 64 kb of buffer is allocated by default. A further description of the algorithm functions is given below.

iNumInputs=Input. The total number of input series.

iInputLen=Input. The length of each input series.

INumOutputs=Input. The total number of output series.

iForecastLen=Input. The desired length of the forecast.

int MaxSettingsLen(int iNumInputs, int iInputLen, int iNumOutputs, int iForecastLen) This function returns the buffer allocation size requested from the algorithm to hold its model settings web form. If not implemented, the standard 64 kb of buffer is allocated by default. A further description of the algorithm functions is given below.

iNumInputs=Input. The total number of input series.

iInputLen=Input. The length of each input series.

INumOutputs=Input. The total number of output series.

iForecastLen=Input. The desired length of the forecast.

Functions Reporting Algorithm Capabilities to the Framework.

int MinInputLen( ). Returns the minimum length of input. Default is 1.

int MaxInputLen( ). Returns the maximum length of input. Default is MAX_INT.

int MinForecastLen( ). Returns the minimum forecast length. Default is 1.

int MaxForecastLen( ). Returns the maximum forecast length. Default is MAX_INT.

int MinNunInputs( ). Returns the minimum number of inputs. Default is 1.

int MaxNumInputs( ). Returns the maximum number of inputs. Default is MAX_INT.

int MinNumOutputs( ). Returns the minimum number of outputs. Default is 1.

int MaxNumOutputs( ). Returns the maximum number of outputs. Default is MAX_INT.

Of all listed functions only one must be implemented to ensure the full functionality of the forecasting algorithms 36 contained within the framework of computational program code 17. Namely, CalculateForecasts( . . . ) all other functions can be safely omitted from implementation, if their default functionality is sufficient and complies to the particular algorithm. Implemented functions from the above list must be compiled into standard windows DLL and exported from it properly. It can be done in any programming language. The resulting DLL module must then be placed into the /ModelDrv subfolder of the original application folder tree. The application must be restarted in order to recognise the newly supplied algorithm.

Referring again to FIG. 1, in addition to the forecasting algorithms (predictors) and statistical functions contained within computational code 17, computer program product 10 also provides filters and tests/targets to further increase the accuracy of predictive forecasts. These filters and tests/targets, contained in computational program code 17, act in conjunction with; portfolio analysis program code 21; program code for charting and display 23; and application programming interface program code 25, in the case of third party vendor applications or plug-ins. Additional portions of computer program products' 10 program code may also be used when functions such as communications or user preferences must be invoked. The forecasting algorithms (predictors) 36 contained within computational program code 17 of computer program product 10 were described above.

Filters assist the forecasting algorithms in improving forecasting accuracy. The way that filters assist in increasing forecasting accuracy is analogous to the way technical analysis helps a human trader determine the best trading opportunities. The filters included in computer program product 10 are too numerous to list and are well known and commonly available and so will not be discussed in detail herein. The unique means of use of the filters included in computer program product 10 through fractal analysis and the fractal metanet server improve the forecasting accuracy of the filters above that of the filters alone.

The tests/targets included in computer program product 10 review the data produced by the predictors and filters and provide a forecast ranking, allowing the selection of the best possible forecasting approach. A listing and brief description of the tests/targets included in computational program code 17 contained in computer program product 10 is provided below.

Asymmetry—Skewness is a measure of the degree of asymmetry of a distribution. If the left tail (at small end of the distribution) is more pronounced that the right tail (at the large end of the distribution), the function is said to have negative skewness. If the reverse is true, it has positive skewness. If the two are equal, it has zero skewness.

Compare to Naive Predictor—Naive predictor is the simplest trivial predictor which predicts price based on its current value. It is good ground for estimation of other algorithms. Any noteworthy algorithm must perform at least the same or better than naive predictor.

Correlation Radius—The correlation radius is a measure for the averaged width of the grains of a rough surface (irregularity).

Cumulative Gain—The sum of all total gains.

Excess—The kurtosis of a distribution is sometimes called the excess, or excess coefficient. Kurtosis is the degree of peakedness of a distribution, defined as a normalized form of the fourth central moment of a distribution.

Friedman—Friedman's test for a randomized complete block design. Test the hypothesis of equality of treatment effects within each block in a randomized block design. The test statistic is the nonparametric analogue of an analysis of variance F test statistic.

H parameter—This is beyond a simple explanation as applied to CUBED. Please contact Tetrahex directly for background information.

Hurst Coefficient—A measure of the bias in fractional Brownian motion. H=0.50 for Brownian motion. 0.50<1.00 for persistent, or trend-reinforcing series. 0<0.50 for an anti-persistent, or mean-reverting system. The inverse of the Hurst exponent is equal to alpha, the characteristic exponent for Stable Paretian distributions. The Fractal dimension of a time series, D, is equivalent to 2-H.

K Sample—This “rank sum” nonparametric k-sample statistic tests the null hypothesis that the location (e.g. median) of the underlying population in 3 or more samples are the same.

Kruskal-Wallis—The Kruskal-Wallis test is a generalization of the Wilcoxon-Mann-Whitney rank sun test for two samples. The inputs to the R function “kruskal” are two columns: the first is a vector of the data values for both groups, and the second is a vector of the same length indicating group membership (e.g. 1, 2, 3, . . . ). A significant difference between samples is present if the returned p value is small, for instance <0.05.

Net Profit—The most common back testing technique when the parameter of optimization is to maximize the profit gain from given original portfolio value.

Additional tests/targets are also contained in computer program product 10, and third party vendor supplied predictors, filters and test/targets can be integrated as well.

It will be appreciated that the predictors, filters and test/targets used in financial analysis are continuously evolving and improving. It will also be appreciated that as technology and user requirements change these improved predictors, filters and test/targets are easily integrated into the fractal metnanet architecture of computer program product 10 through program product updates and/or third party vendor applications, add-ons and plug-ins. Therefore it will be understood that the present invention includes methods, algorithms, analysis functions and technologies not currently available.

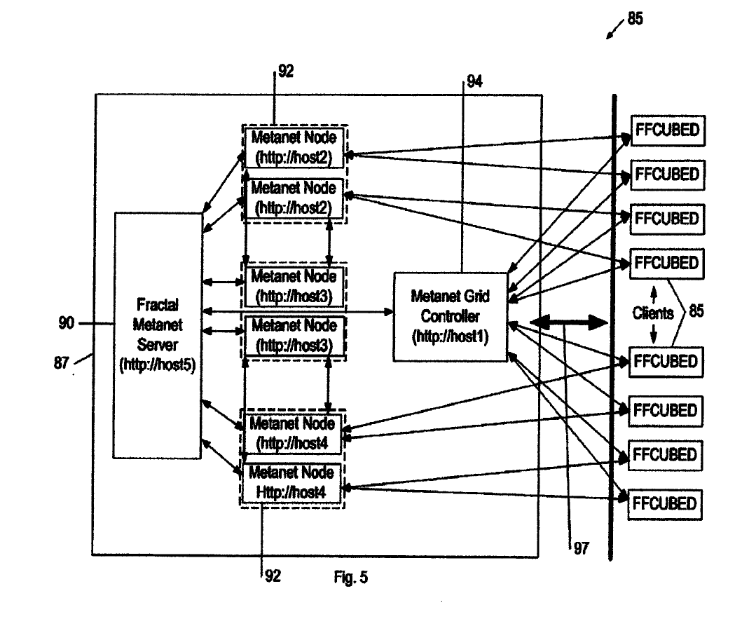

Referring again to FIG. 1, subsequent to forecast model computation by computational program code 17 containing forecasting algorithms 36 (FIG. 2), risk assessment, back-forecasting and model verification are performed by risk assessment program code 19, in conjunction with computational program code 17 and forecasting algorithms 36, as well as user device, communications program code 12, user control code 14 and the fractal metanet server (illustrated in FIGS. 4 and 5). The back-forecasting and model verification evaluates each piece of data individually and as a collective exponential whole. This results in data sets and models that don't rely on curve fitting for prediction.

Portfolio analysis program code 21 (also referred to as Portfolio Optimizer) performs portfolio performance analysis, in conjunction with user control program code 14, computational program code 17, risk assessment program code 19, communications program code 12 and the user device and fractal metanet server illustrated in FIGS. 4 and 5. Portfolio analysis program code 21 is the artificial intelligence system that takes input from all of the data present in the portfolio and searches for the best forecasting technique for each symbol. The results of computations performed by portfolio analysis program code 21 will allow the selection of the best winning symbol combination most appropriate for trading in current market conditions. In addition, portfolio analysis program code 21 will advise which predictors work best with each particular financial data vehicle of interest (e.g., symbols representing stocks, commodities, securities and the like).

Portfolio performance explorations are possible in many different ways. The common starting point is to explore historical trading performance. However, the highly nonlinear distribution of trading signals does not suggest reliance on past profits exhibited by a given trading strategy. This is usually expressed by the well-known adage, “past performance does not guarantee future profits.” Computer program product 10 through portfolio analysis program code 21 provides the user with much more powerful nonlinear exploration techniques. These techniques allow the user to analyze the back testing results of each strategy. This is not accomplished from just a plain profitability basis, but also with accurate nonparametric statistics and chaos criteria. The benefit of such an analysis is much more room for efficient portfolio optimizations.

Portfolio analysis program code 21 acting in conjunction with user control program code 14, containing user defined instructions and preferred selections of predictors, filters and target tests, consecutively computes all combinations of selected forecasting algorithms and presents the best performance based on user criteria. Portfolio analysis program code 21 makes forecasts as an estimate of future price. Future price is predicted one step ahead based on the most finite data in the portfolio database. As an example with EOD data, the most finite step will be one day of data. Targets are selected and predicted one step ahead as well. An example is provided herein.

Computer program product 10 returns data that was computed using net profit and Hurst exponent tests/targets chosen by the user. Using this data, portfolio analysis program code 21 will give a forecast for the next day on both tests/targets. In the event that all tests/targets are selected and only net profit appears, it means that there was not enough data or no convergence of predictors to give a forecast for the other targets. The same holds true for the predictors and filters, however in the case of predictors and filters the best choices are made for each different market. In some cases this will be one predictor, in others it can be all of them.

Portfolio analysis program code 2 takes a list price sequence and then a forecast sequence over the length of the data set. Portfolio analysis program code 21 then tests the series of differences between them with different measures of convergence (e.g. measure (price−forecast)). The most accurate forecast is chosen based on a 1 step ahead forecast (1 day in the case of daily data) and presented as the forecast. Following this step, different measures are made to evaluate the deviations. The results of these measures are displayed, in conjunction with charting and display program code 23 and ranked as results.

Portfolio analysis program code 2 also provides for; Targets and Trades, and a Hot List. In the case of Targets and Trades, portfolio analysis program code 21 lists price targets as the one step ahead prediction. In the case of calculating net profit, a trade is considered complete when the actual price reaches the forecasted price. Net profit of trades is also optimal, not taking into account commissions, slippage or strategy modifications.

The Hot List gives a quick overview of “extreme” performing financial data vehicles of interest. Such financial data vehicles are generally not advised to trade on because such extrema may be due to some convergence deviations in the algorithms and therefore not very reliable. However, they may appear very useful in deeper market analysis.

Extrema are calculated by sorting the full dataset on each performance criteria and taking a number of top and bottom elements from the list as given in the count control on the hot list form. For example, if the number of items is 10, it will take the 10 best and 10 worst of symbols in each category. Categories are defined by performance tests chosen for a given batch scan. There are many chaotic performance measures inside computer program product 10, as well as the standard performance criteria such as ‘net profit’. As a consequence, the exact number of categories and hot list picks depends on the number of categories chosen in the selected scan. For example, if there are two performance categories selected for a given portfolio: ‘net profit’ and ‘Hurst exponent’, then there will be a total of 40 picks: 10 with best ‘net profit’, 10 with worst ‘net profit’, 10 with best ‘Hurst exponent’ and 10 with worst ‘Hurst exponent’. The hot list can be further sorted again to have deeper ordering inside the selected sets.

Charting and Display program code 23 contains the plurality of charting, graphing and display means contained within computer program product 10. Charting and Display program code 23 can also act in conjunction with application programming code interface 25 for integration and use of third party vendor supplied charting and graphing means. Charting and Display program code 23 also controls the manner in which data analysis results and forecasted models are displayed, either via printed media or on a display device. The charting, graphing means included in charting and display program code 23 includes but is not limited to; graphs, charts, tables, multilevel models, three dimensional charts, five dimensional charts, fractal dimension charts, price attractor cube, lag relay cube, and multi-scale tables, said display forms optionally including confidence estimates, projected price targets, three dimensional fractal price attractors, fractal candles and various other indicators and the like. The display means included in charting and display program code 23 includes but is not limited to; video display; touch sensitive screen; LCD display; flat panel display; CRT; monitor; printed media and the like.

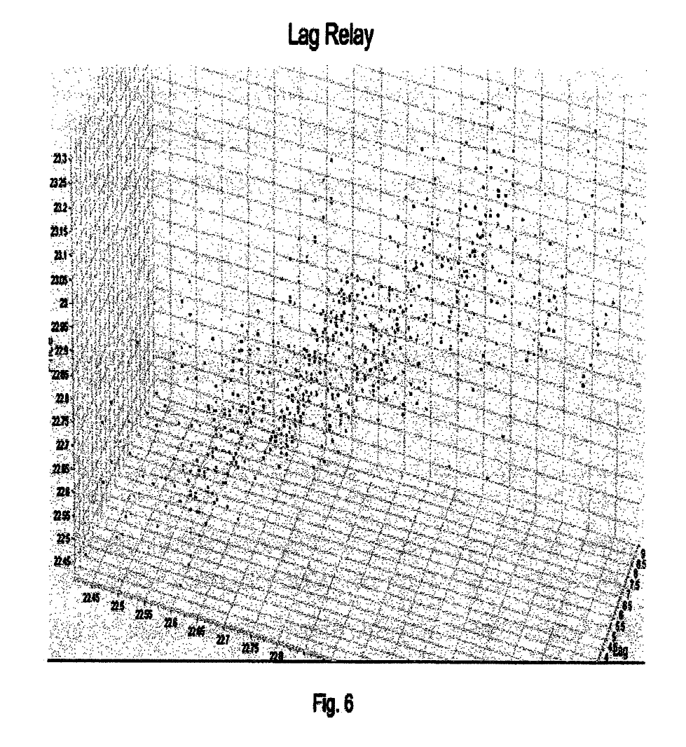

In particular, charting and display program code 23 contain novel charting and graphing means of displaying forecasted data, referred to as the price attractor cube and the lag relay cube, hereinafter referred to as “The Cubes”. The Cubes allow for three-dimensional real time tracking of bid/ask data according to user defined data vehicles of interest and user defined instruction sets. The Cubes also allow for identifying the phase space and price attractors in any given market. Without identifying phase space and price attractors, accurate forecasts are difficult to formulate. Computer program product 10 containing the novel charting and display means within charting and display program code 23 is believed to be the only trading program in the world that displays price attractor information this way (see FIGS. 6, 7 and 8). It will be appreciated that the charting and display means used in financial analysis, as well as the means for displaying the results to the end user, are continuously evolving and improving. It will also be appreciated that as technology and user requirements change these improved charting and display means used in financial analysis, as well as the means for displaying the results to the end user, are easily integrated into computer program product 10, using application programming interface 25, through program product updates and/or third party vendor applications, add-ons and plug-ins. Therefore it will be understood that the present invention includes charting and display technologies not currently available.

Application programming interface program code 25 allows integration of computer program code (software) updates from computer program product 10 manufacturer, as well as providing a means for integration of third party vendor applications, plug-ins and add-ons. Application programming interface program code 25 acts in conjunction with the other program codes contained within computer program product 10 as necessary for functionality. Application programming interfaces useful for adding third party vendor applications, plug-ins or add-ons, as well as being useful allowing software updates provided by the software manufacturer are well know and will not be discussed in detail herein.

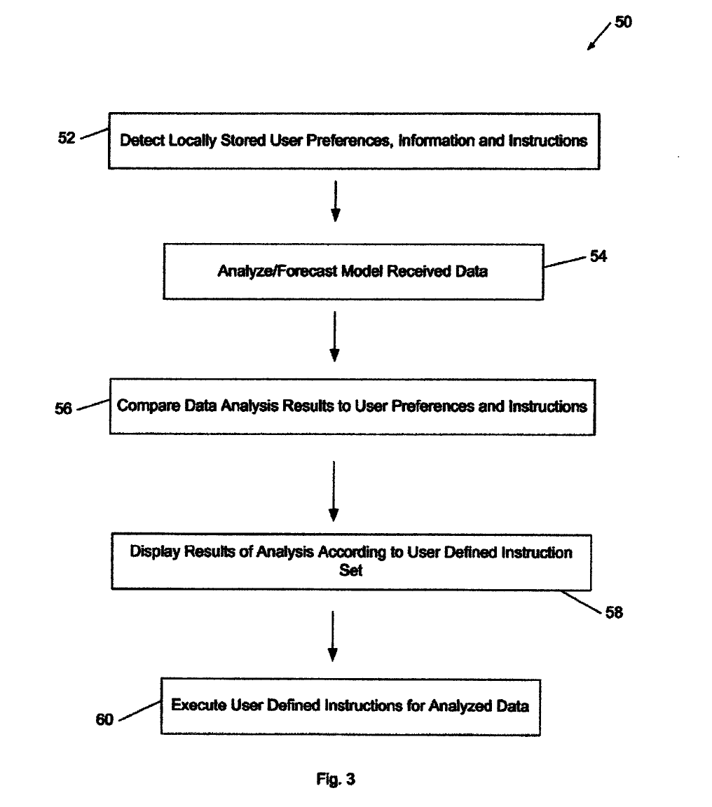

Referring now to FIG. 3, a flowchart describing a process for providing financial data vehicle forecasting and trading functionality 50 is illustrated. The process uses computer program product 10 from FIG. 1 and is based on fractal analysis and fractal metanet architecture. The process also requires a means of executing computer program product 10 and a means of sending and receiving information, particularly for receiving information from a data feed and for bi-directional communication with the software server where all fractal calculations are performed.

Referring now to FIGS. 1 and 3. Process 55 is initiated when the user of a device containing a processor and capable of executing computer applications starts program product 10. Examples of devices capable of devices containing a processor and capable of executing computer applications or computer program code include but are not limited to; desktop computer, laptop computer, mainframe computer, PDA's, Smartphone and the like. It will be appreciated that computing device, chip design, and processor design are continuously evolving and improving. It will also be appreciated that as technology and user requirements change processors of increasing complexity and power are easily substituted for processors currently in use. Therefore it will be understood that the present invention includes processor designs and technologies not currently available.

Upon completion of startup, computer program 10, acting through user control program code 14, detects locally stored user preferences, information and instructions. The locally stored user preferences, information and instructions detected include but are not limited to; data feed access; data vehicles of interest; preferred analysis algorithms; charting/graphing/data presentation; portfolio performance analysis (Portfolio Optimizer); display; auto-execution technology; third party vendor applications and the like.

Upon detection of locally stored user preferences, information and instructions 52, computer program product 10 acting through communications program code 12 receives financial data from a user defined/chosen data feed and associates portfolio information contained in user control program code 14 with data feed. This allows computer program 10, in conjunction with user control program code 14 to determine which data vehicles of interest to track from data feed. Process 50 acting at detecting step 52, in conjunction with user control program code 14 also applies; stored preferences for analysis and forecast modeling algorithms used on data received for data vehicles of interest, authenticates computer program product 10 onto Fractal Metanet Server for fractal computations in conjunction with communications program code 12; applies preferences for portfolio performance analysis/calculations (Portfolio Optimizer); applies user preferences/instructions for auto-execution of financial trading functionality; and tracks/applies third party add-ons and plug-ins as necessary. It will be understood that data vehicles of interest include but are not limited to commodities, securities, stocks and the like.

Process 50 acting through computer program product 10, containing communications program code 12 and user control program code 14 receives data from a financial data feed, and performs data analysis and forecast modeling 54. It will be appreciated that the steps of back-forecasting and model verification are requisite parts of the analysis and forecast modeling step 54, in conjunction with computational program code 17 and risk assessment program code 19, to ensure forecast accuracy. It will also be appreciated that computer program product 10 contains all algorithms, filters, test/targets necessary for data analysis and forecast modeling with the exception of those computations and functions requiring fractal analysis using the fractal metanet server. Therefore it will be understood that the analysis and modeling performed in analyzing and forecast modeling 54 requires repeated communications activity.

Process 50 compares the results of data analysis to the previously associated user preferences and instructions 56. The comparison of the results to the portfolio information contained in user control program 14 allows computer program product 10 in conjunction with portfolio analysis program code 21 and charting and display program code 23 to prepare the results of data analysis for presentation to the user according to user preferences and instructions 52. It will be appreciated that the steps for comparing the analyzed data as well as the steps involved in portfolio analysis and graphical representation and display of the data analysis involve the processing containing device 65 illustrated in FIG. 4. It will be further appreciated that the preferences and instructions to carry out portfolio analysis are held in processor containing device 65 memory and accessed by user control program code 14, which acts in conjunction with communications program code 12, computational program code 17, risk assessment program code 19, portfolio analysis program code 21, and charting and display program code 23. In the event a third party vendor application, plug-in or add-on has been added by user, and is included in the user control instructions, application programming interface program code would also act to allow normal function of the third party application, plug-in or add-on.

Referring again to FIGS. 1 and 3, upon or concurrent with completion of analysis and forecasting of received data 54 and comparison of data analysis results to user preferences and instructions 56, process 50 through computer program product 10 displays the results of analysis in accordance with user defined instructions 58. The term display as used herein refers to both the graphical representation of the results of data analysis and model forecasting, as well as the display of said graphically represented data for user visualization.

Process 50, displaying the results of data analysis according to user defined instructions 58 acts in conjunction with charting and display program code 23 to present the data in accordance with user defined preferences and instructions. The charting and graphing means used in data analysis display step 58 of process 50 and included in charting and display program code 23 includes but is not limited to; graphs, charts, tables, multilevel models, three dimensional charts, five dimensional charts, fractal dimension charts, and multi-scale tables, said display forms optionally including confidence estimates, projected price targets, three dimensional fractal price attractors, fractal candles and various other indicators and the like. In particular, for forecasting and predictive purposes, data analysis display 58 in conjunction with charting and graphing program code 23 enable a novel charting and graphing means of displaying forecasted data, referred to as the price attractor cube and the lag relay cube, collectively referred to as “The Cubes”. The Cubes allow for three-dimensional real time streaming data tracking of bid/ask data according to user defined data vehicles of interest and user defined instruction sets. The Cubes also allow for identifying the phase space and price attractors in any given market, further enhancing the ability of the claimed method to provide highly accurate financial data vehicle forecasting and trading functionality.

Process 50, displaying the results of data analysis according to user defined instructions 58 acts in conjunction with charting and display program code 23 to present the data in accordance with user defined preferences and instructions. The visual display means included in charting and display program code 23 includes but is not limited to; video display; touch sensitive screen; LCD display; flat panel display; CRT; monitor; printed media and the like.

Concurrent with or subsequent to displaying data analysis and modeling results 58, process 50 executes user-defined instructions based on analyzed data 60 for financial vehicles of interest. Process 50 executes user-defined instructions for analyzed data 60, in conjunction with computer program product 10 through user control program code 14, communications program code 12, and in the event of third party applications, application programming interface 25. The user defined instructions for auto-execution of user defined trading instructions include but are not limited to; buy; sell; offer; bid; and ask. Examples of types of user-defined instructions for program level auto-execution include but are not limited to; increase time series, decrease time series, apply different algorithm, apply different filter, apply different test/target, choose best algorithm and the like. It will be appreciated that user-defined auto-execute instructions can be configured for any number of financial data vehicles of interest, with the upper limited being dictated by the computing device configuration. It will also be appreciated that additional analysis or computation can be invoked and auto-executed if data analysis results merit that action. This is useful if the analysis results of a chosen predictor, filter or test/target returned unusable data. It will be further appreciated that the user defined auto-execution instructions can also interact with third party vendor applications, plug-ins and or add-ons. It will also be understood that the execution of trade functionality can be performed manually as well.

Referring now to FIG. 4, a system configured for trading financial data vehicles 63 is illustrated. More particularly, Financial vehicle trading system 63 of the present invention provides a computer program product 72 (software name FFCUBED), executed on a processor containing device 65, in communication 81 with both a financial data feed and a fractal metanet server 83, and a method for providing financial data vehicle forecasting and trading functionality, said system providing a novel financial trading platform using fractal analysis and computations on a fractal metanet server 83.

Financial trading system 63 contains user computing device 65, computer program product 72, communications path 81, and a server or servers 83 providing computational functions and processing for user computing devices executing computer program product 72. User computing device 65 further contains; memory 70; an input system 74; a display system 76; a communications system 79 and a processor 67, performing the steps of;
receiving a financial data feed;
associating financial data feed with locally stored portfolio information;
analyzing/forecast modeling financial data according to user input;
assessing/managing risk of the forecast financial data;
displaying results of financial analysis according to user defined instructions;
comparing financial data analysis to user defined financial trading instructions;
executing user defined trading instructions.

Financial trading system 63 acting through processor 67 and communications system 79 establishes communications 81 with a financial data feed and receives data. Processor 67 then associates the financial data feed being received over communications path 81 with portfolio information locally stored in memory 70 associated with user computing device 65. Processor 67 in conjunction with computer program product 72, memory 70, communications system 79, and fractal metanet server (FFCUBED server) 83, using communications path 81, analyzes received data and prepares forecast models according to user preferences and instructions. It will be understood that in some instances input system 74 will be used to enter or modify preferences or instructions. Input system 74 devices configured for use with financial trading system 63 include but are not limited to; keyboard; keypad; touch sensitive screen; pointer device; camera; video camera; microphone and the like. It will be appreciated that for any given operation performed by input system 74, that some or all of the components of input system 74 will be engaged to carry out the means and methods of that particular operation. Therefore it will be understood that input system 74 will have different hardware, firmware and software needs depending on the operation being performed. It will also be appreciated that server technology and equipment is continuously being improved and developed as user requirements and technology change. Therefore it will be appreciated that the present invention encompasses future server technology and equipment, as switching servers is a relatively easy operation. The construction, integration and operation of servers, in general, is well known, so will not be discussed in detail herein.

Financial trading system 63 acting through processor 67, computer program product 72 and communication system 79 then performs risk assessment of the forecast financial data. Risk assessment is performed in conjunction with fractal metanet server 83, and uses back-forecasting for model verification to assure forecasting accuracy. The back-forecasting and model verification evaluates each piece of data individually and as a collective exponential whole. This results in data sets and models that don't rely on curve fitting for prediction. It will be appreciated that all algorithms, filters, and test/targets are resident in the client software with the exception of fractal algorithms that are used by the fractal metanet server. It will also be appreciated that all computations, with the exception of fractal based computations, which require the fractal metanet server, are performed on user computing device 65.

Financial trading system 63 acting through processor 67 and computer program product 72 and display system 76: is configured to perform the steps necessary for charting and graphing the results of data analysis. The charting and graphing means used in graphical display of analyzed data include, but are not limited to; graphs, charts, tables, multilevel models, three dimensional charts, five dimensional charts, fractal dimension charts, and multi-scale tables, said display forms optionally including confidence estimates, projected price targets, three dimensional fractal price attractors, fractal candles and various other indicators and the like. Financial trading system 63 also enables a novel charting and graphing means that is particularly useful for forecasting and predictive purposes. The novel means of displaying forecasted data, are referred to as the price attractor cube and the lag relay cube, collectively referred to as “The Cubes”. The Cubes allow for three-dimensional real time streaming data tracking of bid/ask data according to user defined data vehicles of interest and user defined instruction sets. The Cubes also allow for identifying the phase space and price attractors in any given market, further enhancing the ability of the claimed method to provide highly accurate financial data vehicle forecasting and trading functionality.

Financial trading system 63 acting through processor 67, computer program product 72 and display system 76 is also configured to perform the steps necessary for visual display of the graphically presented results. The visual display means included in charting and display program code 23 includes but is not limited to; video display; touch sensitive screen; LCD display; flat panel display; CRT; monitor; printed media and the like.

Concurrent with, or subsequent to charting and displaying the results of the analyzed data, financial trading system 63 acting through processor 67, memory 70, and computer program product 72 compares the results of the data analysis to user defined trading instructions for financial data vehicles of interest. This comparison is performed as part of the steps necessary for providing trading functionality. It will be understood that the comparison will necessarily involve multiples steps including but not limited to associating locally stored user preferences and instructions for each data vehicle of interest with data analysis results for that data vehicle of interest; invoking further analysis should the results of data analysis merit further computation, initiating communications with trading broker or carrier of financial data feed, and the like. It will also be understood that in some instances input system 74 will be used to enter or modify preferences or instructions, as well as execute trading functions manually. Input system 74 devices configured for use with financial trading system 63 include but are not limited to; keyboard; keypad; touch sensitive screen; pointer device; camera; video camera; microphone and the like. It will be appreciated that for any given operation performed by input system 74, that some or all of the components of input system 74 will be engaged to carry out the means and methods of that particular operation. Therefore it will be understood that input system 74 will have different hardware, firmware and software needs depending on the operation being performed.

Financial trading system 63 acting through processor 67, memory 70, computer program product 72, and communications system 79 (if necessary), then carry out the function of executing user defined trading instructions. The user defined instructions for auto-execution of trading functionality include but are not limited to; buy; sell; offer; bid; and ask. Examples of types of user-defined instructions for program level auto-execution include but are not limited to; increase time series, decrease time series, apply different algorithm, apply different filter, apply different test/target, choose best algorithm and the like. It will be appreciated that user-defined auto-execute instructions can be configured for any number of financial data vehicles of interest, with the upper limited being dictated by the computing device configuration. It will also be appreciated that additional analysis or computation can be invoked and auto-executed if data analysis results merit that action. It will be understood that in the instance that execution of trading instructions requires use of communication system 79, communications path 81 will also be needed for establishing communications through communication system 79. It will be appreciated that for any given operation performed by communication system 79, that some or all of the components of communication system 79 will be engaged to carry out the means and methods of that particular operation. Therefore it will be understood that communication system 79 will have different hardware, firmware and software needs depending on the operation being performed.

Referring now to FIG. 5, the general architecture of the fractal metanet 85 is illustrated. The fractal metanet 85 contains; host 87; fractal metanet server 90 (illustrated as FFCUBED server 83 in FIG. 4), metanet nodes 92, the metanet controller grid 94, communications path 97, and client computers executing the computer program product of the present invention 100. The fractal metanet host 87 houses permissioning software and performs fractal-based computations. All other aspects of the current invention are performed on the clients computing device executing the software of the present invention.

Fractal metanet host 87 contains: fractal metanet server(s) 90 (illustrated as FFCUBED server 83 in FIG. 4), metanet nodes 92, the metanet controller grid 94, and communications path 97. The fractal metanet host 87 describes the virtual operating environment created by the hardware, firmware and software operationally connected by the present invention. The fractal metanet host 87 receives permissioning requests for computational resource allocation from clients 100 executing the computer program product of the current invention. Each device within fractal metanet host 87 has a unique server address as illustrated in FIG. 5 (http://host1 to http://host?, where ? is a number corresponding to a particular node on the fractal metanet 85 grid.), used to assign job requests and identify computations stored in fractal metanet server 90 memory. It will be appreciated that as fractal metanet host 87 forms part of fractal metanets' 85 processing and computing infrastructure, fractal metanet host 87 also contains the processors and computing devices necessary to provide normal network functionality. It will also be appreciated that computing device, chip design, and processor design are continuously evolving and improving. It will also be appreciated that as technology and user requirements change processors of increasing complexity and power are easily substituted for processors currently in use. Therefore it will be understood that the present invention includes processor designs and technologies not currently available.

Fractal metanet Server 90 is a network server containing the processors, devices, hardware, firmware and software necessary to provide normal computer network functionality. Fractal metanet server 90 contains memory to store results of computations performed by metanet nodes 92 prior to returning data to client 100, as well as performing all processes necessary for normal network functionality. It will be appreciated that server technology and equipment is continuously being improved and developed as user requirements and technology change. Therefore it will be appreciated that the present invention encompasses future server technology and equipment, as switching servers is a relatively easy operation. It will also be appreciated that computing device, chip design, and processor design are continuously evolving and improving. Therefore, it will also be appreciated that as technology and user requirements change processors of increasing complexity and power are easily substituted for processors currently in use. Therefore it will be understood that the present invention includes processor designs and technologies not currently available.

Metanet nodes 92 (also referred to as worker nodes), are computing devices containing the processors, devices, hardware, firmware and software necessary to provide normal computer functionality. The metanet nodes 92 perform the majority of the computations involved in calculating the modeling forecasts. Metanet nodes 92 also perform the task of processing client requests. The metanet nodes 92 are resource-consuming applications that are completely isolated away from the metanet grid controller. The metanet nodes 92 are isolated to ensure efficient resource recycling in case of faults. The isolation of the metanet nodes 92 is accomplished in the manner the computational resources are allocated by metanet grid controller 94. When a metanet node completes its job, the results are stored in the memory of fractal metanet server 90, where the results can then be distributed to the client. Different metanet servers can reside on different physical machines completely remote from each other, and communicate with each other and the fractal metanet server 90 containing a relational database management system (RDBMS) through the network. The relational database software is used to manage the data from completed computational job requests. The metanet server 90, metanet nodes 92 and host controller grid 94, can all communicate with each other through the network with inter-node synchronization occurring by SOAP messaging. Briefly, SOAP is a protocol for exchanging XML-based messages over a computer network, normally using HTTP SOAP forms the foundation layer of the Web services stack, providing a basic messaging framework that more abstract layers can build on. The configuration chosen for the metanet host 87 allows virtually unlimited scalability, especially on powerful RDBMS installations allowing parallel query processing, as is found with clustered Oracle servers. A further advantage of the “isolated” metanet server architecture is that splitting the workload between several physically distinct machines gives excellent fault tolerance and fault recovery due to resource redundancy. This allows client requests to be processed even in the event of a physical crash of one or more metanet nodes 92.

Metanet grid controller 94 is a centralized job manager responsible for load balancing and task distribution. Metanet grid controller 94 also controls task completion and automatic recovery in case of failures, with automatic switch of tasks between grid nodes. Metanet grid controller 94 is a limited functionality server responsible for processing client login requests, distributing work requests to metanet nodes 92 and returning the new server address to the client, for communication during computation and computation result retrieval. Each metanet node 92 is equipped with local grid service responsible for local distribution of tasks between processors. However in the even of a node failure metanet grid controller 94 can automatically switch work to a different metanet node 92 for task completion. It will be appreciated that server technology and equipment is continuously being improved and developed as user requirements and technology change. Therefore it will be appreciated that the present invention encompasses future server technology and equipment, as switching servers is a relatively easy operation. The construction, integration and operation of servers, in general, in networks is well known, so will not be discussed in detail herein.

An example of the method for providing a financial vehicle trading system using the fractal metanet is provided herein. Client computer 100 receives financial data from a financial data feed. Using the computer program product of the current invention, client computer 100 begins analysis and modeling of financial data vehicles of interest. While analysis is ongoing, client computer 100 executing the computer program product of the current invention initiates a login request with metanet host 87 over communications path 97. Metanet grid controller 94 processes login request and passes job assignment to an available metanet node 92 (assigned metanet node 92). Metanet grid controller 94 returns new server address to client computer 100 for communication with metanet node 92 processing job request. Client computer 100 continues analysis of financial data vehicles received from financial data feed in conjunction with assigned fractal metanet node 92. Assigned fractal metanet node 92 provides fractal computations as needed for model forecasting, back-forecasting and model verification. Assigned fractal metanet node 92 stores completed fractal computations in fractal metanet server 90, for distribution to client computer 100.

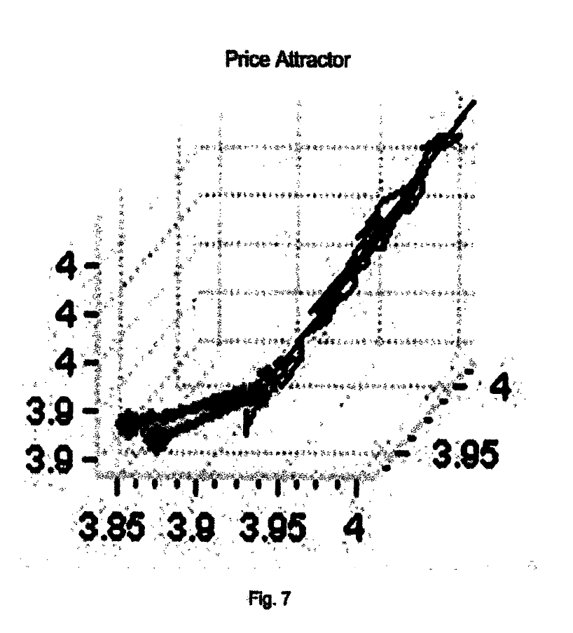

Client computer 100 completes analysis and forecast modeling in conjunction with fractal metanet host 87. Results of data analysis are graphically displayed according to user defined preferences and instructions. Using the novel charting means Lag Relay Cube (illustrated in FIG. 6) and Price Attractor cube (illustrated in FIG. 7), and other methods of displaying analyzed data, client computer 100 executing the computer program product of the present invention identifies trading opportunities and market trends. Identified trading opportunities and market trends are compared to user defined preferences and instructions, including Portfolio Optimizer analysis. Client computer 100 using the computer program product of the current invention then executes user defined trading instructions.

It will be appreciated that the computer program product of the current invention contains program code enabling integration of third party vendor applications, plug-ins and add-ons, through the use of an application programming interface. Therefore, it will be understood that the additional features offered by third party vendor applications, plug-ins and add-ons can be used in conjunction with the fractal metanet 85 through the computer program code of the present invention.

While particular preferred and alternative embodiments of the present intention have been disclosed, it will be apparent to one of ordinary skill in the art that many various modifications and extensions of the above described technology may be implemented using the teaching of this invention described herein. All such modifications and extensions are intended to be included within the true spirit and scope of the invention as discussed in the appended

What is claimed is:

1. A computer program product, wherein on a computer readable medium a plurality of computer program codes are embodied in the medium and a computer executes the plurality of computer program codes to produce the computer program product, comprising:
a plurality of data feeds;
a plurality of random and chaotic data vehicles;
a first computer readable program code for communications connectivity and data feed access;
a second computer readable program code to identify and track user defined data vehicles of interest;
a third computer readable program code for performing statistical analysis and forecast modeling using univariate and unlimited dimension multivariate analysis algorithms and fractal metanet architecture based algorithms of at least one type of data selected from the plurality of random and chaotic data vehicles received from the plurality of data feeds, and produce an output of statistical data related to the plurality of random and chaotic data vehicles;
a fourth computer readable program code for risk assessment the plurality of random and chaotic data vehicles;
a fifth computer readable program code for comparing the output of statistical data by the computer program product to a set of user defined parameters and executing instructions based on the user defined parameters, as well as electronically executing a user configured instruction set for at least one of manually and automatically displaying and reporting of the statistically analyzed data;
a sixth computer readable program code for integration of additional program codes and third party developed applications; and,
a seventh computer readable program code for charting and displaying computer program product.

2. The computer readable program code, as recited in claim 1, wherein at least one of the plurality of random and chaotic data vehicles and user selected data vehicles of interest, from the plurality of data feeds, is financial data.

3. The computer readable program code, as recited in claim 2, wherein the financial data is selected from commodities.

4. The computer readable program code, as recited in claim 1, wherein the plurality of data vehicles are analyzed/forecast modeled over a user-defined period of time.

5. The computer readable program code, as recited in claim 1, wherein the second computer readable program code further tracks, updates and stores user selected preferences and instructions.

6. The computer readable program code, as recited in claim 1, wherein the third computer readable program code further comprises three main parts: input data, output model and a forecasting algorithm.

7. The computer readable program code, as recited in claim 1, wherein the fourth computer readable program code further comprises artificial intelligence allowing combinations of various forecasting algorithms, predictors, filters, tests and the like, the program code artificial intelligence capable of identifying and applying best combination of algorithms, predictors, filters, tests, for the selected financial data vehicles, according to user defined preferences and instructions.

8. The computer readable program code, as recited in 1, wherein the third computer readable program code further comprises a program code multilevel univariate, multivariate and fractal metanet based analysis.

9. The computer readable program code, as recited in claim 8, wherein the results of the multilevel analysis are analyzed and mined for trading opportunities.

10. The computer readable program code, as recited in claim 1, wherein the fourth computer readable program code further comprises a program code for model verification using back forecasting.

11. The computer readable program code, as recited in claim 10, wherein the time intervals used in model verification are identical to the user-defined time period used in analyzing/forecast modeling data received from the data feed.

12. The computer readable program code, as recited in claim 1, wherein the seventh computer readable program code further comprises a program code for three-dimensional real time tracking of bid/ask data according to user defined data vehicles of interest and user defined instruction sets.

13. The computer readable program code, as recited in claim 12, wherein the seventh computer readable program code further comprises a program code for identifying the phase space and price attractors in one of the user selected data feeds.

14. The computer readable program code, as recited in claim 15, wherein the seventh computer readable program code further charts and electronically displays statistically analyzed data selected from a group consisting of; graphs, charts, tables, multilevel models, three dimensional charts, five dimensional charts, fractal charts, price attractor cube, and multi-scale tables, wherein the user may select a display form to include at least one of confidence estimates, projected price targets, three dimensional fractal price attractors and fractal candles.

15. The computer readable program code, as recited in claim 16, wherein the sixth computer readable program code further comprises a program code for unattended automated operation and auto-execute capability providing data vehicle forecasting and trading functionality in the absence of continued human interaction.

16. The computer readable program code, as recited in claim 1, wherein the analyzed data is displayed according to user configured instructions on one at least one of an electronic display and printed media.

17. A random and chaotic data vehicle forecasting method comprising the steps of:
inputting data feeds from a plurality of random and chaotic data vehicles;
inputting a user profile to include user selected data vehicles from the plurality of random and chaotic data vehicles;
analyzing and forecast modeling of the user selected data vehicles received from the data feeds, using univariate and unlimited dimension multivariate statistical analysis, wherein the analyzing and forecast modeling includes access to the plurality of data feeds, identifying and tracking the user selected data vehicles of interest, performing statistical analysis and forecast modeling using fractal metanet architecture based algorithms, and performing risk assessment forecasts on the user selected data vehicles; and,
displaying results of the analyzing and forecast modeling step.

18. The method, as recited in claim 17, wherein the plurality of random and chaotic data vehicles are financial data and the user profile further includes financial trading indicators and user defined trading instructions.

19. The method, as recited in claim 18, wherein the financial data is selected from commodities.

20. The method, as recited in claim 18, further comprising the steps of:
comparing the analyzing and forecast modeling step to the financial trading indicators of the inputting user profile step; and,
executing the user defined trading instructions in the inputting user profile step.

21. The method, as recited in claim 17, wherein the analyzing and forecast modeling step further comprises multilevel univariate, multivariate and fractal metanet architecture based algorithms.

22. The method, as recited in claim 21, wherein the results of the multilevel analysis are analyzed and mined for trading opportunities.

23. The method, as recited in claim 17, wherein the risk assessment of the analyzing and forecast modeling step uses an artificial intelligence system, which determines the best forecasting technique for each of the plurality of data vehicles from the user selected data vehicles of interest.

24. The method, as recited in claim 17, wherein the analyzing and forecast modeling step further comprises a model verification using back forecasting having time intervals to a user-defined time period for analyzing and forecast modeling of the plurality of data vehicles received from the user selected data vehicles.

25. The method, as recited in claim 17, wherein the analyzing and forecast modeling step further comprises three-dimensional real time tracking of bid and ask data according to the user selected data vehicles of interest and user defined instruction from the inputting a user profile step.

26. The method, as recited in claim 17, wherein the steps are executed on a device containing a computer processor of at least one of a computer, a main frame, personal digital assistant (PDA) and a Smartphone.

27. A multivariate financial statistical forecasting system comprising:
a computer program, wherein on a computer readable medium a plurality of computer program codes are embodied in the medium and a computer executes the plurality of computer program codes to produce the multivariate financial statistical forecasting system;
a plurality of financial data feeds;
a plurality of random and chaotic financial data vehicles;
a first computer readable program code for communications connectivity and financial data feed access;
a second computer readable program code to identify and track user defined financial data vehicles of interest;
a third computer readable program code for performing statistical analysis and forecast modeling using univariate and unlimited dimension multivariate analysis algorithms and fractal metanet architecture based algorithms of at least one type of data selected from the plurality of random and chaotic financial data vehicles received from the plurality of financial data feeds, and produce an output of statistical data related to the plurality of random and chaotic financial data vehicles;
a fourth computer readable program code for risk assessment the plurality of random and chaotic financial data vehicles;
a fifth computer readable program code for comparing the output of statistical data by the computer program product to a set of user defined parameters and executing instructions based on the user defined parameters, as well as electronically executing a user configured instruction set for at least one of manually and automatically displaying and reporting of the statistically analyzed data;
a sixth computer readable program code for integration of additional program codes and third party developed applications; and,
a seventh computer readable program code for charting and displaying computer program product.

28. A method of providing a financial vehicle trading system comprising:
a computer readable program product, wherein the computer readable program product comprises a computer usable medium having computer readable program code means embodied in said medium for causing an application program to execute on a computer that receives at least one data feed, said computer program product performing; univariate, multivariate, and fractal based analysis for statistical forecasting of at least one type of data selected from; random and chaotic data vehicles received from at least one data feeds, and output of the statistical data related to the data vehicles of interest as well as electronically executing user configured instruction sets for displaying and reporting of said statistically analyzed data, said computer readable program code means comprising; a first computer readable program code providing communications connectivity to a data feed; a second computer readable program code to identify and track user defined data vehicles of interest; a third computer readable program code means for performing statistical analysis and forecast modeling using univariate and unlimited dimension multivariate analysis algorithms and fractal metanet architecture based algorithms and program coding; a fourth computer readable program code means for risk assessment financial vehicle forecasts; a fifth computer readable program code means for comparing the data forecast by the computer readable program code to user defined parameters and executing instruction sets based on user defined data analysis parameters; a sixth computer readable program code means for charting and displaying statistically analyzed data; a seventh computer readable program code for integration of additional program codes and third party developed applications (Application Programming Interface); a fractal metanet server; a communications path; memory; user input controls; a display; and a processor, wherein the method comprises the steps of:
receiving financial data feed;
associating financial data feed with locally stored portfolio information;
analyzing/forecast modeling financial data according to user input;
assessing/managing risk of the forecast financial data;
displaying results of financial analysis according to user defined instructions;
comparing financial data analysis to user defined financial trading instructions; and,
executing user defined trading instructions.

29. The financial vehicle trading system, as recited in claim 28, wherein at least one display is selected from the group consisting of; video display; touch sensitive screen; LCD display; flat panel display; CRT; monitor; and printed media.

30. The financial vehicle trading system, as recited in claim 28, wherein the communications path is selected from the group consisting of; Internet, broadband Internet, wireless broadband Internet, telephony, wireless telephony, Digital Subscriber Line (DSL), satellite Internet, and World Wide Web.

31. The financial vehicle trading system, as recited in claim 28, wherein the user input controls are selected from the group consisting of; keyboard, mouse, touch sensitive screen, pointer, PDA stylus, keypad, and a tablet.

32. The financial vehicle trading system, as recited in claim 28, further comprising three-dimensional real time tracking of bid and ask data according to user defined data vehicles of interest and user defined instruction sets.

33. The financial vehicle trading system, as recited in claim 28, wherein the three dimensional real time data tracking is presented using at least one of The Lag Relay Cube and The Price Attractor Cube.

34. The financial vehicle trading system, as recited in claim 28, wherein the user defined display instructions display the output forecasting data using at least one of the forms selected from the group consisting of graphs, charts, tables, multilevel models, three dimensional charts, five dimensional charts, fractal charts, price attractor cube, and multi-scale tables, the display forms including confidence estimates, projected price targets, three dimensional fractal price attractors, and fractal candles.

35. The financial trading vehicle trading system, as recited in claim 28, further comprising unattended automated operation and auto-execute capability providing financial data vehicle forecasting and trading functionality in the absence of continued human interaction
